(19) United States
(12) Patent Application Publication
(10) Pub. No.: US 2016/0009022 A1
(43) Pub. Date: Jan. 14, 2016

(54) IMPRINT APPARATUS AND ARTICLE MANUFACTURING METHOD

(71) Applicant: CANON KABUSHIKI KAISHA, Tokyo (JP)

(72) Inventors: Yozo Matsuda, Utsunomiya-shi (JP); Yusuke Tanaka, Tokyo (JP); Kohei Wakabayashi, Utsunomiya-shi (JP)

(21) Appl. No.: 14/795,028

(22) Filed: Jul. 9, 2015

(30) Foreign Application Priority Data
Jul. 11, 2014 (JP) 2014-143656

(51) Int. Cl. B29C 59/02; B29C 43/58; B29C 43/36

(52) U.S. Cl. CPC B29C 59/022; B29C 59/026; B29C 43/36; B29C 43/58; B29C 2043/3602

(57) ABSTRACT

An imprint apparatus includes plural pressing members configured to press a side surface of a mold and plural actuators configured to drive each pressing member in a direction parallel to the pattern surface. The each pressing member has a tapered portion on a side of the mold. A contact portion contacting the side surface of the mold out of the tapered portion extends in a direction perpendicular to the pattern surface.

### BACKGROUND OF THE INVENTION

1. Field of the Invention

The present invention relates to an imprint apparatus and an article manufacturing method.

2. Description of the Related Art

As a request for micropatterning of a semiconductor device advances, a microfabrication technique of bringing a mold and an uncured resin on a substrate into contact with each other to form a resin pattern on the substrate has received attention, in addition to a conventional photolithography technique. This technique is also called an imprint technique and can form a fine structure on the substrate on the several nm order. A photo-curing method is one example of the imprint technique. In the photo-curing method, first, an ultraviolet-curing resin (imprint material) is coated in a shot region (imprint region) on a substrate (wafer). Next, this uncured resin and the mold are brought into contact with each other. Then, the mold is released after the resin is cured by ultraviolet irradiation in a state in which the resin and the mold are brought into contact with each other, thereby forming the resin pattern on the substrate.

An imprint apparatus which adopts the above-described technique generally includes a shape correction mechanism which corrects the shape of a pattern generated during a semiconductor process. This shape correction mechanism applies an external force to the mold, thereby deforming the mold itself and correcting a pattern shape formed on the mold. The pattern shape has an influence on overlay accuracy of patterns. Therefore, highly accurate correction of several nm or less is needed to cope with the microfabrication of the patterns.

Japanese Patent Laid-Open No. 2013-254938 has disclosed an imprint apparatus which applies a compression force to the side surface of a mold via a pressing member and performs magnification correction. In the imprint apparatus disclosed in Japanese Patent Laid-Open No. 2013-254938, a detector D detects a deformation amount in the peripheral region of the mold in the vertical direction (−Z direction), and adjusts the angle of the pressing member in the ωy direction so as to reduce the deformation amount in the −Z direction if the side surface of the mold is not perpendicular to the pattern surface of the mold. Japanese Patent Laid-Open No. 2013-254938 has also disclosed that, as shown in FIG. 9, the shape of the distal end of the pressing member when viewed from the y direction is formed into a convex shape in order to easily bring the pressing member into contact with a neutral position even if the side surface of the mold is not perpendicular to the pattern surface. The shape correction mechanism described in Japanese Patent Laid-Open No. 2013-254938 includes, as shown in FIG. 9, four pressing members 21 which press one side surface of a mold 3, and the contact states of four contact portions between these four pressing members 21 and the side surface of the mold 3 are the same.

The shape correction mechanism corrects the shape of the mold by driving the plurality of pressing members arranged to surround the side surface of the mold. The contact portions between the plurality of pressing members and the side surface of the mold are in the different contact states in respective points. Therefore, forces are applied to the mold with different magnitudes in the different directions, a distortion may occur in, for example, the oz direction, and the complexly distorted shape of the mold may be obtained. The imprint apparatus described in patent literature 1 on the assumption that the contact states in the plurality of contact portions are the same cannot cope with such a complexly distorted shape of the mold sufficiently.

### SUMMARY OF THE INVENTION

The present invention provides an imprint apparatus advantageous in transferring a mold pattern to a substrate accurately.

The present invention provides an imprint apparatus for forming a pattern on a substrate by bringing a pattern surface of a mold into contact with an imprint material on the substrate, the apparatus comprising: a plurality of pressing members configured to press a side surface of the mold; and a plurality of actuators configured to drive each of the plurality of pressing members in a direction parallel to the pattern surface, wherein each of the plurality of pressing members has, on a side of the mold, a tapered portion which has a cross-sectional shape tapered obtained by cutting each of the plurality of pressing members in a plane parallel to the pattern surface, and has a shape by which a contact portion contacting the side surface of the mold out of the tapered portion extends in a direction perpendicular to the pattern surface.

Further features of the present invention will become apparent from the following description of exemplary embodiments with reference to the attached drawings.

### BRIEF DESCRIPTION OF THE DRAWINGS

FIG. 1 is a schematic view showing the arrangement of an imprint apparatus according to the present invention;

FIG. 2 is a schematic view showing the arrangement of a mold holding unit according to the present invention;

FIGS. 3A and 3B are schematic views showing the arrangement of a shape correction mechanism according to the present invention;

FIG. 4 is a flowchart showing an operation of the imprint apparatus according to the present invention;

FIGS. 5A and 5B are conceptual views each showing the state of a mold in a pressing operation;

FIGS. 6A and 6B are conceptual views showing deformation if there is a processing error in the mold;

FIGS. 7A and 7B are conceptual views each showing the mold and pressing members according to the present invention;

FIGS. 8A to 8F are views each for explaining the shape of the distal end of the pressing member according to the present invention; and

FIG. 9 is a view showing the mold and the pressing members in a related art.

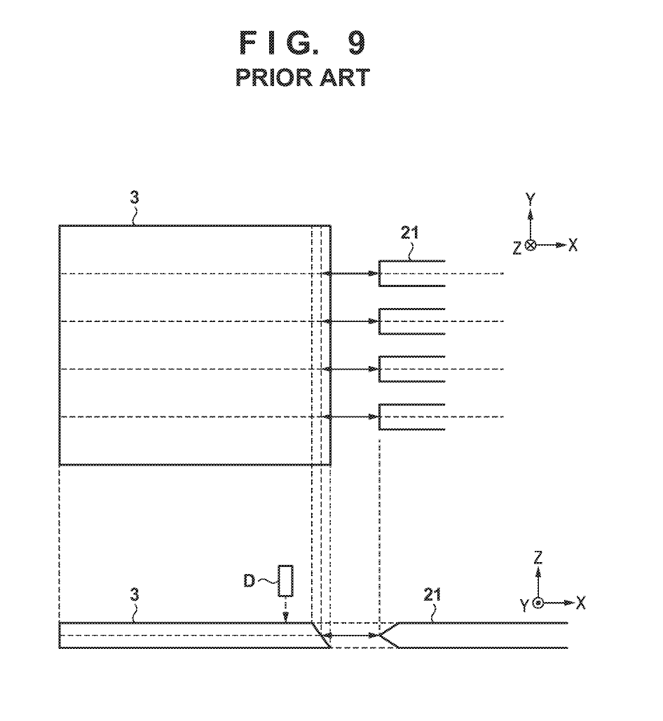

### DESCRIPTION OF THE EMBODIMENTS

Modes for carrying out the present invention will be described below with reference to, for example, the accompanying drawings.

[Imprint Apparatus]

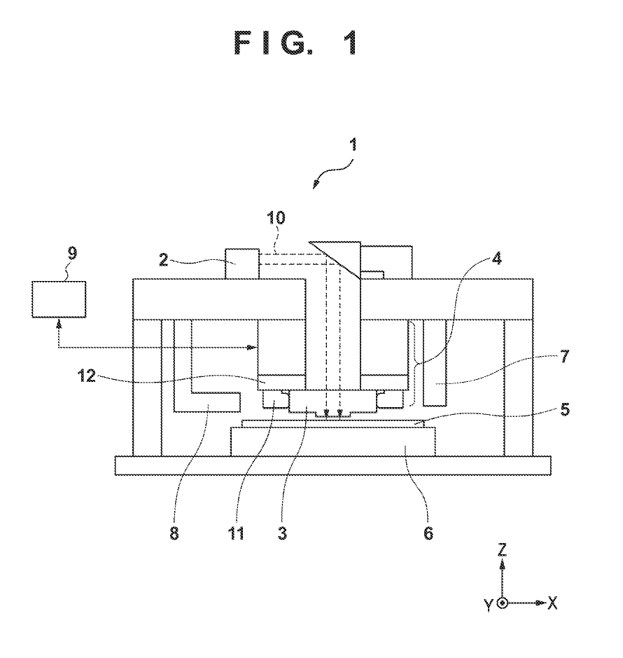

First, the arrangement of an imprint apparatus according to an embodiment of the present invention will be described. FIG. 1 is a schematic view showing the arrangement of an imprint apparatus. The imprint apparatus according to this embodiment transfers the three-dimensional pattern of a mold onto a wafer (substrate) serving as a target processing substrate used in a semiconductor device manufacturing process, and adopts a photo-curing method. A description will be made below by setting the Z-axis in parallel to the irradiation axis of ultraviolet rays with respect to the mold, setting the X-axis in the driving direction of a pressing member out of a shape correction mechanism to be described later on a plane perpendicular to the Z-axis, and setting the Y-axis in the direction perpendicular to the X-axis and the Z-axis. An imprint apparatus 1 includes an illumination unit 2, a mold (a die, a die material, or a metal die) 3, a mold holding unit 4, a wafer (substrate) 5, a wafer stage (substrate stage) 6, a coating unit (dispenser) 7, a mold conveying unit 8, and a controller 9.

The illumination unit 2 irradiates the mold 3 with ultraviolet rays 10 in an imprint process. The illumination unit 2 includes a light source, and a plurality of optical elements configured to adjust the ultraviolet rays emitted from the light source to light suitable for imprinting. The mold 3 has a rectangular outer shape. A predetermined pattern (for example, the three-dimensional pattern such as a circuit pattern) is three-dimensionally formed on a pattern surface 3a facing the wafer 5. The pattern surface 3a is processed to have high flatness so as to maintain tight contact with the surface of the wafer 5. The mold 3 is made of a material such as quartz capable of transmitting the ultraviolet rays.

The mold holding unit 4 holds the mold 3. The mold holding unit 4 includes a shape correction mechanism 11 and a mold chuck 12. The shape correction mechanism 11 corrects a three-dimensional pattern formed on the mold 3 by applying a force to the side surface of the mold 3. The mold chuck 12 draws and holds the mold 3 by a vacuum suction force or an electrostatic force. The mold holding unit 4 also includes a driving mechanism (not shown) which drives the mold chuck 12. More specifically, the driving mechanism of the mold chuck 12 drives the mold chuck 12 in the Z-axis direction to bring the mold 3 and an ultraviolet-curing resin on the wafer 5 into contact with each other. An actuator adapted for the driving mechanism is not particularly limited as long as it is driven in at least the Z-axis direction. A linear motor, an air cylinder, or the like can be adapted. When performing a mold releasing operation of separating the mold 3 from the ultraviolet-curing resin, the actuator may perform a coarse operation and a fine operation dividedly in order to perform the mold releasing operation accurately so as not to damage the cured ultraviolet-curing resin. This mold pressing operation (mold contacting operation) and the mold releasing operation may be implemented by driving the mold 3 in the Z direction. However, they may be implemented by, for example, driving the wafer stage 6 in the Z direction. Alternatively, they may be implemented by driving both the mold chuck 12 and the wafer stage 6.

The wafer 5 is, for example, a target processing substrate made of single-crystal silicon and its target processing surface is coated with the ultraviolet-curing resin (resin). The wafer stage 6 holds the wafer 5 by vacuum chuck and is movable freely on the X-Y plane. The linear motor can be adopted as the actuator configured to drive the wafer stage 6. However, the present invention is not particularly limited to this. The coating unit (dispenser) 7 dispenses (supplies) an uncured resin onto the wafer 5. The resin is a photo-curing resin (imprint material) having a property of curing upon receiving the ultraviolet rays and is selected based on the type of semiconductor device to be manufactured. The mold conveying unit 8 conveys the mold 3 and installs the mold 3 on the mold chuck 12.

The controller 9 controls the operation, adjustment, and the like of each component of the imprint apparatus 1. The controller 9 is constituted by a computer, a sequencer, or the like (not shown) including a storage unit such as a magnetic storage media connected to each component of the imprint apparatus 1 by a circuit, and controls each component by a program or a sequence. Particularly, in this embodiment, the controller 9 adjusts the clamp force (drawing force) of the mold chuck 12, and controls the operations of the shape correction mechanism 11, a gas supply unit, and the like to be described later. Note that the controller 9 may be arranged as a part of the imprint apparatus 1 or may be installed on a separate place from the imprint apparatus 1 and perform remote control.

[Mold Holding Unit]

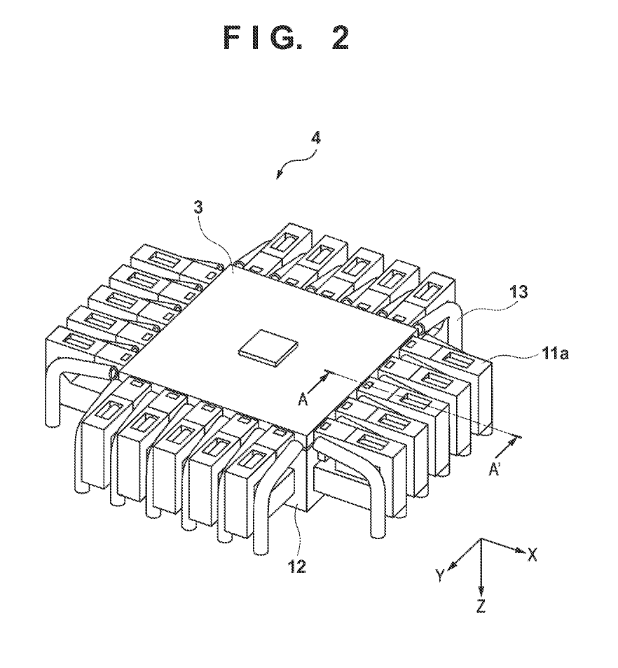

The mold holding unit 4 according to this embodiment of the present invention will be described. FIG. 2 is a perspective view showing the arrangement of the mold holding unit 4 when viewed from the side of the wafer 5. The mold holding unit 4 includes, so as to surround four side surfaces of the mold 3, the shape correction mechanism 11 and a plurality of pipes 13 configured to supply and recover a gas between the mold 3 and the wafer 5. As shown in FIG. 2, the shape correction mechanism 11 according to this embodiment installs five shape correction elements 11a for the one side surface of the mold 3, that is, the 20 shape correction elements 11a in total around the mold 3. In this embodiment, the six pipes 13 for every between the shape correction elements 11a, that is, for the one side surface of the mold. In total, the 24 pipes 13 are installed around the mold 3. The number of shape correction elements 11a to be installed can change depending on a pattern shape or target accuracy. The number and the shapes of pipes 13 can also change as long as a sufficient amount of gas can be supplied. Each pipe 13 supplies the necessary amount of gas such as helium from a gas supply source (not shown). Leakage of the gas to be supplied may cause a length measurement error of a measuring device such as a position measurement interferometer normally installed on the wafer stage 6. Therefore, sufficient exhaustion (recovery) is needed.

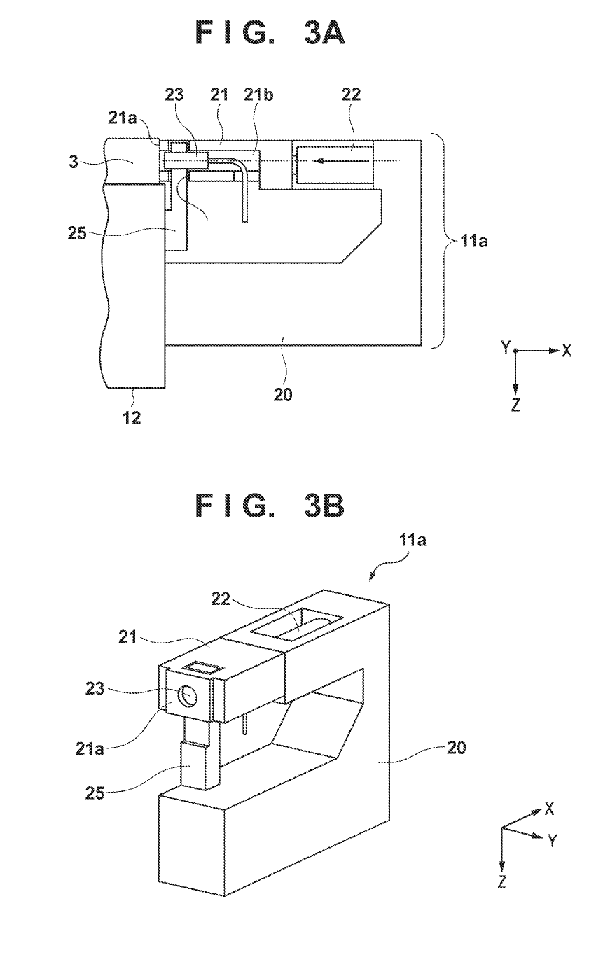

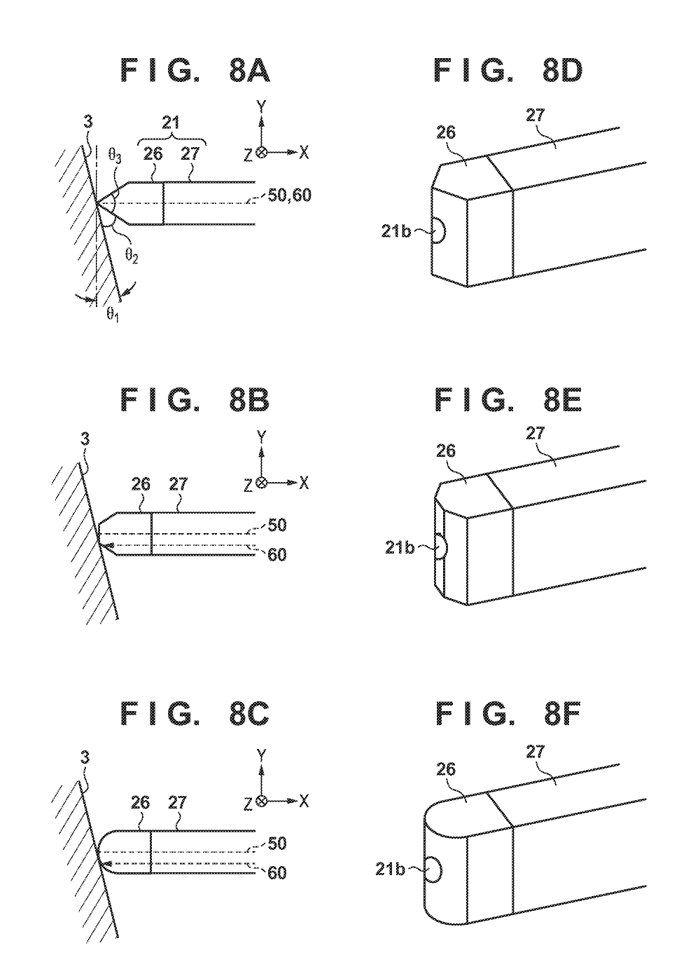

The arrangement of each shape correction element 11a will now be described. FIGS. 3A and 3B are schematic views showing the arrangement of the shape correction element 11a. FIG. 3A is a view showing a section taken along a line A-A′ in FIG. 2. FIG. 3B is a perspective view when viewed from the side of the mold 3. As shown in FIGS. 3A and 3B, the shape correction element 11a includes a supporting member 20 which forms a main body, a pressing member 21 which presses the side surface of the mold 3, and an actuator 22 which is installed on the supporting member 20 and drives the pressing member 21. The supporting member 20 is a member having the U-shaped side surface when viewed from the Y-axis direction and fixed to the side surface of the mold chuck 12. The pressing member 21 brings a contact surface (pressure surface) 21a into contact with the side surface of the mold 3 and is movable in the X-axis direction so as to apply a force (compression force) to the mold 3. The actuator 22 is installed coaxially with the moving axis of the pressing member 21 and transmits a driving force (compression force) to the pressing member 21. For example, a piezoelectric element, a pneumatic actuator, or a linear motor can be used as the actuator 22. Note that the installation positions (relative positions) of the pressing member 21 and the actuator 22 are determined arbitrarily. The actuator 22 may not be installed coaxially with the moving axis of the pressing member 21. As shown in FIGS. 8A to 8F, the pressing member 21 is made of a distal end portion 26 and a base portion 27. A resin formed from tetrafluoroethylene, polyoxymethylene or polymide, or a resin with excellent elasticity, such as polyetheretherketone (PEEK material) is used for the distal end portion 26. This makes it possible to relax stress concentration on the mold 3 and to prevent damage to the mold 3.

A position sensor (detector) 23 configured to detect the position and deformation of the mold 3 is installed in the shape correction element 11a. An optical sensor, an eddy current sensor, an electrostatic capacitance sensor, or the like can be used as the position sensor 23. In the pressing member 21 according to this embodiment, an opening 21b is formed from the central portion of the contact surface 21a toward the inside the member. The position sensor 23 is arranged inside the opening 21b. The detection position of the position sensor 23 is set to the center position of the contact surface 21a of the pressing member 21. In FIGS. 3A and 3B, an introduction port which extends through the opening 21b in the vertical direction is formed in the pressing member 21, and the position sensor 23 is fixed to the mold chuck 12 and held by a supporting member 25 introduced to the opening 21b via the introduction port. The position sensor 23 does not contact the pressing member 21 substantially. Further, the pressing member 21 is movable in the X direction without contacting the position sensor 23.

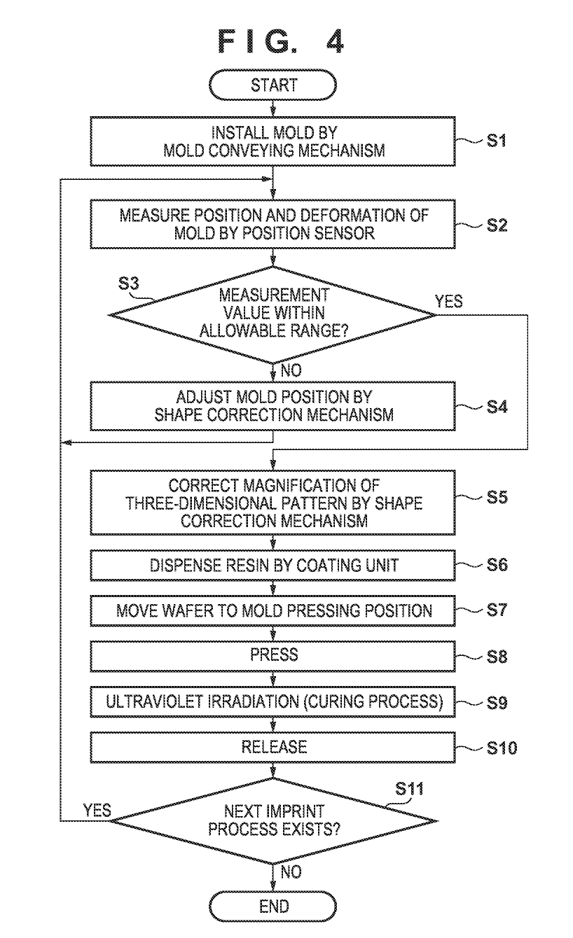

An imprint process by the imprint apparatus 1 where the mold holding unit 4 is installed will now be described. FIG. 4 is a flowchart showing the sequence of the imprint process. Once an operation sequence is started, the controller 9 causes the mold conveying unit 8 to install the mold 3 on the mold chuck 12 in step S1. In step S2, the controller 9 uses the three position sensors 23 installed in at least the three shape correction elements 11a out of the shape correction mechanism 11 to obtain values of the position and deformation of the mold 3. Note that the pressing member 21 of the shape correction mechanism 11 does not contact the mold 3 in this state. In step S3, the controller 9 determines, based on the detection result of the position sensor 23, whether the deviation of the position of the mold 3 from a target position or the deviation of the shape of the mold 3 from a target shape fall within an allowable range. If the controller 9 determines that the value of the obtained position does not fall within the allowable range (NO), the controller 9 drives the shape correction mechanism 11 so as to adjust the position of the mold 3 by setting at least one of the target position and the target shape to a target value in step S4.

After adjusting the position of the mold 3 in step S4, the process returns to step S2 again. If the controller 9 determines, in step S3, that the detected value falls within the allowable range (YES), the controller 9 drives the shape correction mechanism 11 such that the three-dimensional pattern of the mold 3 has the target shape and performs magnification correction in step S5. In this case, the shape correction mechanism 11 presses the pressing member 21 against the mold 3, thereby deforming the mold 3 to be compressed. The controller 9 determines a deformation amount at this time based on the value detected by the position sensor 23.

In step S6, the controller 9 drives the wafer stage 6 to move the wafer 5 to the coating position of the coating unit 7 and causes the coating unit 7 to dispense the resin onto the surface of the wafer 5. In step S7, the controller 9 drives the wafer stage 6 to move the wafer 5 to a mold pressing position. In step S8, the controller 9 performs a mold pressing operation of pressing the mold 3 against the processing region of the wafer 5 coated with the resin (bringing a pattern surface of a mold into contact with an imprint material on the substrate) and fills the three-dimensional pattern formed on the mold 3 with the resin. In step S9, the controller 9 irradiates the resin which fills the three-dimensional pattern of the mold 3 with the ultraviolet rays and solidifies (cures) the resin on the surface of the wafer 5 (curing process). In step S10, the controller 9 separates the mold 3 from the cured resin (mold releasing operation) by expanding the spacing between the mold 3 and the wafer 5. In step S11, the controller 9 determines whether there is an additional next imprint process. If the controller 9 determines that there is the additional next imprint process (YES), the wafer stage 6 is moved to a next imprint position, and then the process returns to step S2 again. On the other hand, if the controller 9 determines, in step S11, that there is no next imprint process (NO), the imprint process ends.

As described above, the controller 9 determines, in step S3, whether a detection value regarding the position and the shape (deformation) of the mold 3 by the position sensor 23 falls within an allowable range set in advance. That is, the position sensor 23 is required to achieve good measurement accuracy. To achieve this, in the present invention, the position sensor 23 is arranged so as not to contact the pressing member 21 as described above and to set a measurement position to the center portion of the contact surface 21a which actually applies the compression force to the mold 3. This makes it possible to further increase measurement accuracy.

Note that the position deviation of the mold 3 may occur because the force is applied to the mold 3 in the resin filling operation and the mold releasing operation described above. Thus, for example, the position and deformation of the mold 3 may fully be monitored by the position sensor 23. In this case, for example, after the mold releasing operation in step S10, the controller 9 measures the position of the mold 3 by the position sensor 23 as in step S2 and if the position deviation does not fall within the allowable range, the controller 9 can perform position adjustment of the mold 3 as in step S4. The controller 9 may perform position adjustment of the mold 3 in step S4 by driving the wafer stage 6 by a position deviation amount measured by the position sensor 23.

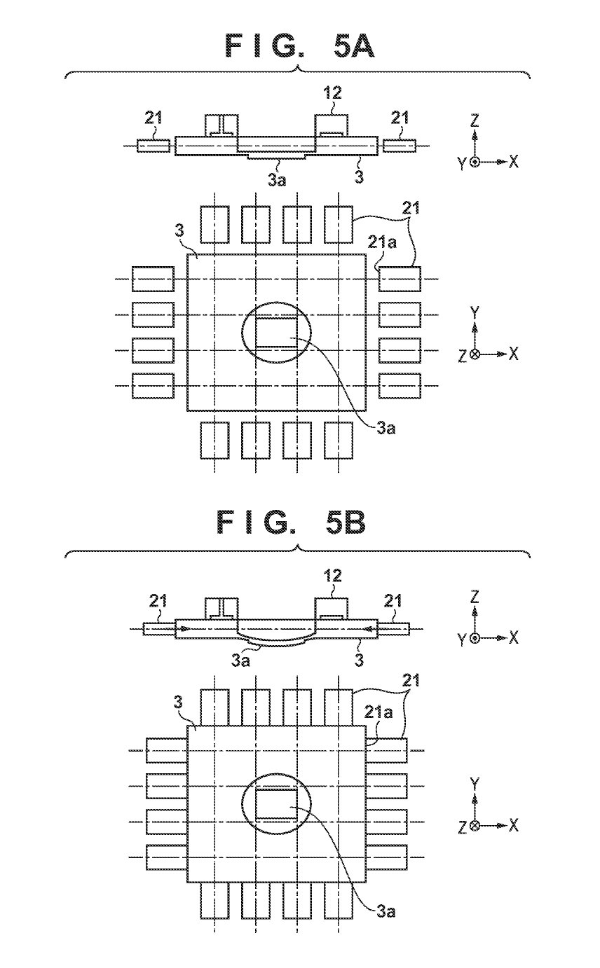

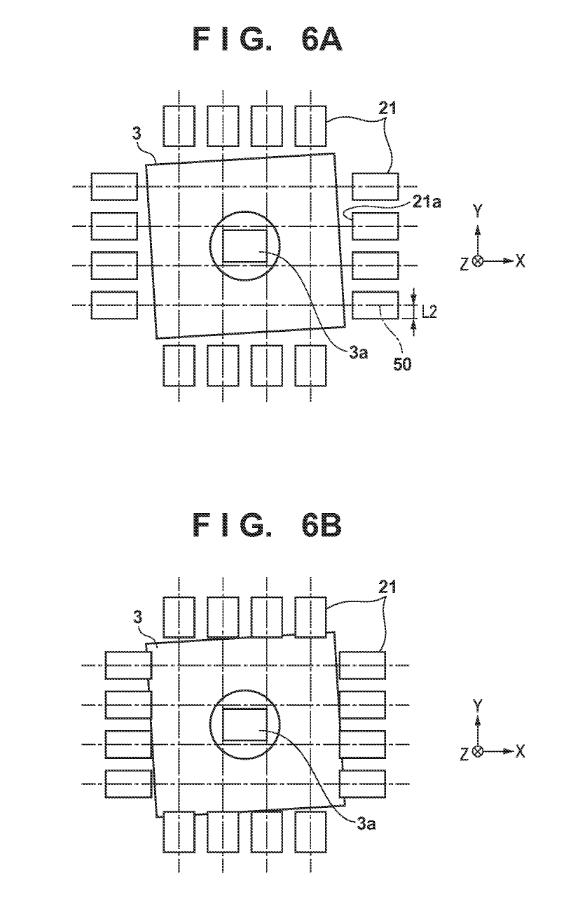

Deformation of the mold 3 before and after the process in step S4 will be described below in detail. FIGS. 5A and 5B are views each showing the state of the mold 3 when pressing the mold 3 against the resin on the wafer 5. First, FIG. 5A is the view showing the state before applying the compression force to the mold 3 by the shape correction mechanism 11. From this state, the plurality of pressing members 21 of the shape correction mechanism 11 contact the side surfaces of the mold 3 and the compression force is applied. In FIGS. 5A and 5B, assume that ideally, the side surfaces of the mold 3 and the contact surfaces 21a of the pressing members 21 are parallel to each other, and a force can be applied to a neutral position of the mold 3 in the Z direction. By doing so, the vicinity of the thin pattern surface 3a (a region where the three-dimensional pattern is formed) of the mold 3 is deformed in the Z direction, as shown in FIG. 5B. In practice, however, the side surfaces of the mold 3 may not be parallel to the contact surfaces 21a of the pressing members 21 in the shape correction mechanism 11 when viewed from the vertical direction, as shown in FIG. 6A, owing to an error in the installation position and a manufacturing error of the mold 3. Considering the positioning method and the manufacturing cost of the mold 3, it is difficult to eliminate the above-described errors. If the compression force is applied to the mold 3 of FIG. 6A by the shape correction mechanism 11, each pressing member 21 contacts a neutral position 50 from a position away by L2 in the Y direction, as shown in FIG. 6A. In this case, the mold 3 is deformed asymmetrically. Because of this deformation, the pattern surface 3a of the mold 3 cannot be corrected accurately, decreasing overlay accuracy. Note that the direction when viewed from each side surface of the mold 3 is defined as the horizontal direction and the direction vertical to the horizontal direction is defined as the vertical direction.

In order to reduce the decrease in overlay accuracy caused by an error of the mold 3, a cross-sectional shape (a shape when viewed from the Z direction) obtained by cutting each pressing member 21 in a plane parallel to the pattern surface 3a of the mold 3 is formed into a convex shape. The side surfaces of the mold 3 and the contact surfaces 21a of the pressing members 21 can be parallel to each other as shown in FIG. 5A, and the contact surfaces 21a of the pressing members 21 can contact the mold 3 uniquely by setting the neutral position of the mold 3 as the center as shown in FIG. 5B. In practice, however, it is difficult, as shown in FIG. 6B, to bring the contact surfaces 21a of the pressing members 21 into contact with the side surfaces of the mold 3 in parallel owing to processing and adjustment errors of the mold 3 and the contact surfaces 21a. Consequently, the end faces of the mold 3 and the peripheral portions of the contact surfaces 21a are in contact with each other, resulting in pressing a portion largely deviated from the neutral position of the mold 3.

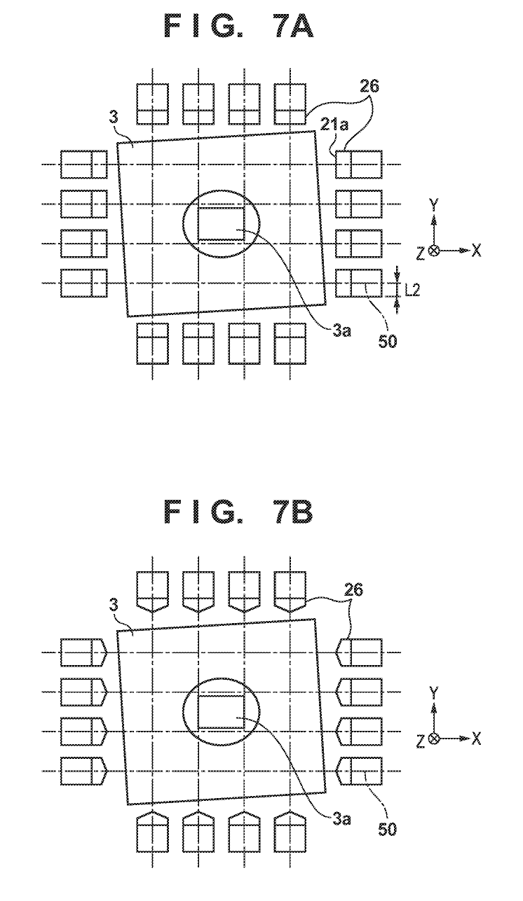

In order to solve the aforementioned problem, the shape of the distal end portion 26 of each pressing member 21 when viewed from the Z direction is formed into a convex shape having a tapered portion tapering toward a tip. FIG. 7B is a schematic view when the shape of the distal end portion 26 of each pressing member 21 is formed into the convex shape. In this case, each distal end portion 26 can contact the mold 3 by setting the neutral position 50 of the mold 3 as the center even if the mold 3 is tilted when viewed from the Z direction. As shown in FIG. 7B, the shape of each pressing member 21 on the distal end side is formed into the convex shape, thereby bringing the pressing member 21 into contact with the mold 3 by setting the neutral position 50 as the center even if a tilt occurs in each side surface of the mold 3 when viewed from the vertical direction.

On the other hand, if the distal end side of the pressing member 21 is formed into the convex shape and a ridge (contact portion) extending in the Z direction is formed, a stress may be concentrated on each side surface of the mold 3 when pressing the side surface of the mold 3 in some cases, resulting in damage to the mold 3. It is therefore necessary to select the shape and the material of each distal end portion 26 which prevent the damage to the mold 3. The cross-sectional shape of the tapered portion of the pressing member 21 can be, for example, a triangle (polygon) as shown in FIGS. 8A and 8D, a trapezoid (polygon) as shown in FIGS. 8B and 8E, or a cylindrical shape as shown in FIGS. 8C and 8F. As shown in FIGS. 8C and 8F, if the cross-sectional shape of the tapered portion of the pressing member 21 has the cylindrical shape, it includes a periphery formed by a curve on the side of the mold 3.

In this embodiment, the cross-sectional shape of the tapered portion of the pressing member 21 needs to be determined in considering the influence of the opening 21b. In a case in which the cross-sectional shape is the trapezoid as shown in FIGS. 8B and 8E or the cylindrical shape as shown in FIGS. 8C and 8F, the pressing member 21 contacts the side surface of the mold 3 in a position 60 different from the neutral position 50 of the pressing member 21 if the side surface of the mold 3 is tilted when viewed from the Z direction. However, divergence of the position 60 where the pressing member 21 contacts the side surface of the mold 3 from the neutral position 50 of the pressing member 21 is much smaller as compared with a case in which the distal end portion 26 of the pressing member 21 is not the convex shape. A case in which the cross-sectional shape of the tapered portion is the triangle will now be described. If the cross-sectional shape is formed into the triangle, the vertex of the triangle positioned on the side of the mold 3 can be placed at a position on the side surface of the mold 3 to be pressed. This makes it possible to match all of a position on the side surface of the mold 3 which is to be pressed, a contact position of the pressing member 21 with the side surface of the mold 3, and the neutral position of the pressing member 21 with each other even if the side surface of the mold 3 is tilted when viewed from the Z direction.

Therefore, if the distal end portion 26 of the pressing member 21 has the convex shape, the pressing member 21 can be brought into contact with the side surface of the mold 3 in a position near the neutral position 50 of the pressing member 21 even if there are the processing and manufacturing errors of the mold 3 and the pressing member 21. If the cross-sectional shape is the triangle, the vertex of the triangle can match the center of the opening 21b.

If the opening 21b is not provided, the cross-sectional shape of the tapered portion of the pressing member 21 need not be the triangle but may be the convex shape such as the cylindrical shape. In this case, the position sensors 23 may be arranged, for example, between the respective shape correction mechanisms 11. Problems such as difficulty in managing a displacement input amount so as to bring the pressing member 21 portion into line contact with the mold 3 and easy wear are posed in a case in which the cross-sectional shape of the tapered portion is the triangle. In order to alleviate these problems, the shape as shown in FIG. 8E can be obtained in a range in which an effect of bringing the mold 3 and the pressing member 21 into contact with each other near the neutral position of the pressing member 21 can be expected. If a material having a low Young's modulus is used as the distal end portion 26 of the pressing member 21, it is advantageous in terms of the stress but it may lead to a loss of the driving stroke of the shape correction mechanism 11. Therefore, the material and the thickness of the distal end portion 26 need to be determined so as to satisfy the constraint conditions of both the stress and the stroke.

In a case in which the cross-sectional shape of the tapered portion of the pressing member 21 is formed into the triangle will be described in detail. In this case, the vertex of the triangle is made to be positioned in the portion on the side surface of the mold 3 which is to be pressed or in proximity to that position. At this time, the vertex can be positioned to be, for example, 250 μm or less from the position on the side surface of the mold 3 which is to be pressed. As shown in FIG. 8A, letting θ1 be an angle made by the side surface of the mold 3 and the Y-Z plane perpendicular to the driving direction of the pressing member 21, and θ2 be an angle made by the Y-Z plane and an inclined surface on the distal end side of the pressing member 21, a relation θ1<θ2 is established such that the pressing member 21 does not contact the side surface of the mold 3. The upper limit of θ2 can be determined so as to satisfy the constraint conditions of both the stress and the stroke.

[Article Manufacturing Method]

A manufacturing method of a device (such as a semiconductor integrated circuit device or a liquid crystal display device) as an article includes a step of forming a pattern onto a substrate (a wafer, a glass plate, or a film-like substrate) using the above-mentioned imprint apparatus. This manufacturing method can also include a step of etching the substrate on which the pattern has been formed. Note that when other articles such as a patterned medium (recording medium) and an optical element are to be manufactured, this manufacturing method can include other processes of processing the substrate on which the pattern has been formed, instead of etching. The article manufacturing method according to this embodiment is advantageous in at least one of the performance, quality, productivity, and production cost of the article, as compared to a conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-143656, filed Jul. 11, 2014, which is hereby incorporated by reference herein in its entirety.

What is claimed is:

1. An imprint apparatus for forming a pattern on a substrate by bringing a pattern surface of a mold into contact with an imprint material on the substrate, the apparatus comprising:
a plurality of pressing members configured to press a side surface of the mold; and
a plurality of actuators configured to drive each of the plurality of pressing members in a direction parallel to the pattern surface,
wherein each of the plurality of pressing members has, on a side of the mold, a tapered portion which has a cross-sectional shape tapered obtained by cutting each of the plurality of pressing members in a plane parallel to the pattern surface, and has a shape by which a contact portion contacting the side surface of the mold out of the tapered portion extends in a direction perpendicular to the pattern surface.

2. The apparatus according to claim 1, wherein the cross-sectional shape of the tapered portion is a polygon.

3. The apparatus according to claim 2, wherein the cross-sectional shape of the tapered portion is a triangle.

4. The apparatus according to claim 2, wherein the cross-sectional shape of the tapered portion is a trapezoid.

5. The apparatus according to claim 1, wherein the cross-sectional shape of the tapered portion includes a periphery formed by a curve on the side of the mold.

6. The apparatus according to claim 1, wherein each of the plurality of pressing members has an opening extending in a driving direction, and
the imprint apparatus further includes a plurality of detectors each arranged in the opening and configured to detect a position of the mold in the driving direction.

7. The apparatus according to claim 6, further comprising a controller configured to obtain, based on detection results of the plurality of detectors, a value of a deviation of at least one of a deviation from a target position of the position of the mold on the plane parallel to the pattern surface and a deviation from a target shape of a shape of the mold, and control driving of each of the plurality of actuators so as to reduce the value of the obtained deviation.

8. A method of manufacturing an article, the method comprising:
bringing a pattern surface of a mold into contact with an imprint material on a substrate to form a pattern of a resin on the substrate by using an imprint apparatus; and
processing the substrate, on which the pattern has been formed, to manufacture the article,
the imprint apparatus including:
a plurality of pressing members configured to press a side surface of the mold; and
a plurality of actuators configured to drive each of the plurality of pressing members in a direction parallel to the pattern surface,
wherein each of the plurality of pressing members has, on a side of the mold, a tapered portion which has a cross-sectional shape tapered obtained by cutting each of the plurality of pressing members in a plane parallel to the pattern surface, and has a shape by which a contact portion contacting the side surface of the mold out of the tapered portion extends in a direction perpendicular to the pattern surface.
